(19) United States
(12) Patent Application Publication
(10) Pub. No.: US 2013/0185162 A1
(43) Pub. Date: Jul. 18, 2013

(54) ADVERTISEMENT MANAGEMENT SYSTEM AND METHOD

(71) Applicant: Glenna K. Mo, Chicago, IL (US)

(72) Inventor: Glenna K. Mo, Chicago, IL (US)

(21) Appl. No.: 13/349,344

(22) Filed: Jan. 12, 2012

(51) Int. Cl. G06Q 30/02

(52) U.S. Cl. 705/14.69; 705/14.72

(57) ABSTRACT

A system and method is provided for deploying an advertisement campaign to one or more media systems in a network. A user interacts with a data entry form provided by server to enter advertisement content, advertising details, such as the type of advertisement and start and end dates for a desired advertisement campaign. The user also selects the location of one or more media systems to deploy the advertisement campaign. The user submits payment for the advertisement campaign to the server electronically. The advertising content is reviewed and if approved the advertising content is deployed to the selected media system locations.

### RELATED APPLICATIONS

Not Applicable.

### FEDERALLY SPONSORED RESEARCH OR DEVELOPMENT

Not Applicable.

### COMPACT DISK APPENDIX

Not Applicable.

### BACKGROUND

Businesses and other institutions often use advertising or marketing agencies to develop and/or place advertisements for their products, goods, and/or services. These agencies work with such advertisers in developing a market message, graphics, printing, and deployment of the advertisement message. The process of working with an advertising or marketing agency to develop a message can be time consuming (weeks/months) and require high development/logistical expenses.

Digital advertising has enabled businesses and other institutions to use various electronic methods (Internet, wireless, wired, etc.) to provide potential customers information about their goods, products, and/or services in a timely and cost effective manner. Conventional advertising requires an advertisement to be created, printed, delivered to a location, and then manually posted on the display medium (mounting ads/posters on walls, windows, counters, or hanging from ceilings). The cost and time savings in the electronic delivery and posting are enormous. The lead times for printing, delivery and posting are also dramatically reduced. In the event a printed ad has an error or it is discovered that information needs to be added or changed, the modification can be accomplished in a matter of minutes with no wasted print materials or expedited printing and delivery costs. Posters and signs do not have to be taken down or replaced, resulting in the elimination of manpower to perform such tasks.

Conventional digital and Internet campaign software can handle the deployment of ad material to remote locations, however, conventional digital and Internet advertising systems do not provide advertisers sufficient flexibility to customize advertisement campaign content, identify locations for deploying advertisement campaigns, and modify advertisement campaigns that have been deployed. As a result, interacting with such conventional digital and Internet advertising systems can be frustrating to users and, thus, lowering the overall effectiveness of the advertisement both for the advertiser and the user.

### SUMMARY

According to one aspect, a system is provided for deploying an advertisement campaign. The system includes at least one data source that stores media system data. The media system data includes a list of a plurality of media systems and a network location for each of the plurality of media systems. The system also includes at least one processor that is encoded with a plurality of instructions that are executable by the processor.

The processor executes instructions to process advertisement content included in a received advertisement campaign creation request to determine if the advertisement content comprises approved advertisement content. The received advertisement campaign creation request also includes advertisement detail data and a selection of at least one of the plurality of media systems. The advertisement detail data includes an advertisement type, an advertisement size, a start date, and an end date.

The processor also executes instructions to generate an advertisement campaign when the advertisement content is approved advertisement content. The advertising campaign includes the approved advertisement content and the advertisement detail data. The processor further executes instructions to transmit the advertisement campaign to the selection of the at least one plurality of media systems at a corresponding network location to display the approved advertisement content.

According to another aspect, a method is provided for deploying an advertisement campaign. The method includes retrieving media system data from a data source. The media system data includes a network location for each of a plurality of media systems. The method also includes transmitting the network location for each of a plurality of media systems to a remote computing device for display.

The method also includes receiving an advertisement campaign creation request from the remote computing device at a processor. The advertisement campaign creation request includes advertisement content, advertisement detail data, and a selection of at least one of the plurality of media systems. The advertisement detail data comprises an advertisement type, an advertisement size, a start date, and an end date.

The method also includes processing the advertisement content at the processor to determine if the advertisement content comprises approved advertisement content for display. The method also includes generating an advertisement campaign at the processor when the advertisement content comprises approved advertisement content. The advertising campaign includes the approved advertisement content and the advertisement detail data. The method further includes transmitting the advertisement campaign to the selection of the at least one plurality of media systems at a corresponding network location to display the approved advertisement content.

According to one aspect, a system is provided for deploying an advertisement campaign. The system includes at least one data source that stores media system data. The media system data includes a list of a plurality of media systems and a network location for each of the plurality of media systems. The system also includes at least one processor that is encoded with a plurality of instructions that are executable by the processor.

The processor executes instructions to process advertisement content included in a received advertisement campaign creation request to determine if the advertisement content comprises approved advertisement content. The received advertisement campaign creation request also includes advertisement detail data and a selection of at least one of the plurality of media systems. The advertisement detail data includes an advertisement type, an advertisement size, a start date, and an end date.

The processor also executes instructions to generate an advertisement campaign when the advertisement content is approved advertisement content. The advertising campaign includes the approved advertisement content and the advertisement detail data. The processor also executes instructions to determine a price for the advertisement campaign based on the advertisement detail data and the selection of at least one of the plurality of media systems and receive a payment request comprising an electronic payment for the price. The processor further executes instructions to transmit the advertisement campaign to the selection of the at least one plurality of media systems at a corresponding network location to display the approved advertisement content.

### BRIEF DESCRIPTION OF THE DRAWINGS

FIG. 1A is a block diagram of a computing system that includes an advertisement management system.

FIG. 1B depicts an exemplary embodiment of a client computer according to one aspect of the advertisement management system.

FIG. 1C depicts an exemplary embodiment of a data source according to an aspect of the advertisement management system.

FIG. 1D depicts an exemplary embodiment of a media system according to an aspect of the advertisement management system.

FIG. 2 is another block diagram of a computing system that includes an advertisement management system.

FIG. 3 is a block diagram of a computing device configured with an advertisement management application according to one aspect of the advertisement management system.

FIGS. 4A-4C are screen shots of data entry forms according to aspects of the advertisement management system.

FIG. 5 is a process flow depicting a method for creating and deploying and advertisement campaign according to an aspect of the advertisement management system.

### DETAILED DESCRIPTION

Aspects of an advertisement management system (AMS) described herein provide an improved system and method for advertisers to create advertisement campaigns for deployment at one or more media player systems. Other aspects of the AMS enable advertisers to search for locations of media player systems that match search criteria of interest to advertisers.

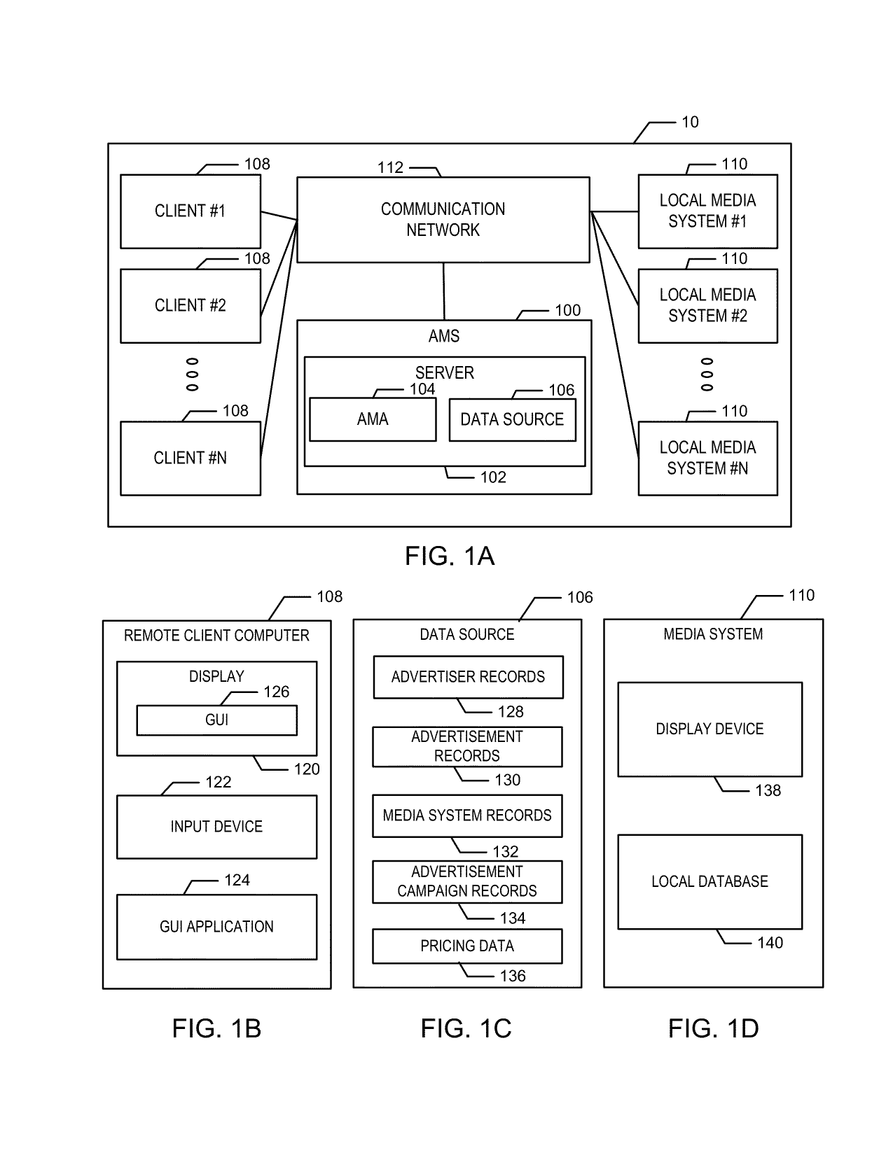

FIG. 1A depicts an exemplary computing network 10 that includes an advertisement management system (AMS) 100 in accordance with aspects of the invention. The AMS 100 includes a server computer (server) 102 that includes an advertisement management application (AMA) 104 and a data source 106. The AMS 100 is linked to one or more client computers (e.g., clients #1-#N) 108 and is linked to one or more media player systems (e.g., media systems #1-#N) 110 via a communication network 112. Although the data source 106 is shown as being located on, at, or within the server 102, it is contemplated that the data source 106 can be located remotely from the server 102 in other aspects of the AMS 100, such as on, at, or within a database of another computing device or system having at least one processor and volatile and/or non-volatile memory.

The server 102 is a computer or computing device that includes one or more processors and memory and executes the AMA 104 to manage the storage of advertiser data, advertisement content, and/or advertisement detail data in the data source 106 and to manage the deployment of an advertisement campaign (ad campaign) to the remote media systems 110 for display. The server 102 is configured to receive data from and/or transmit data to the one or more clients 108 through the communication network 112. The server 102 is also configured to transmit data to the one or more remote media systems 110 through the communication network 112.

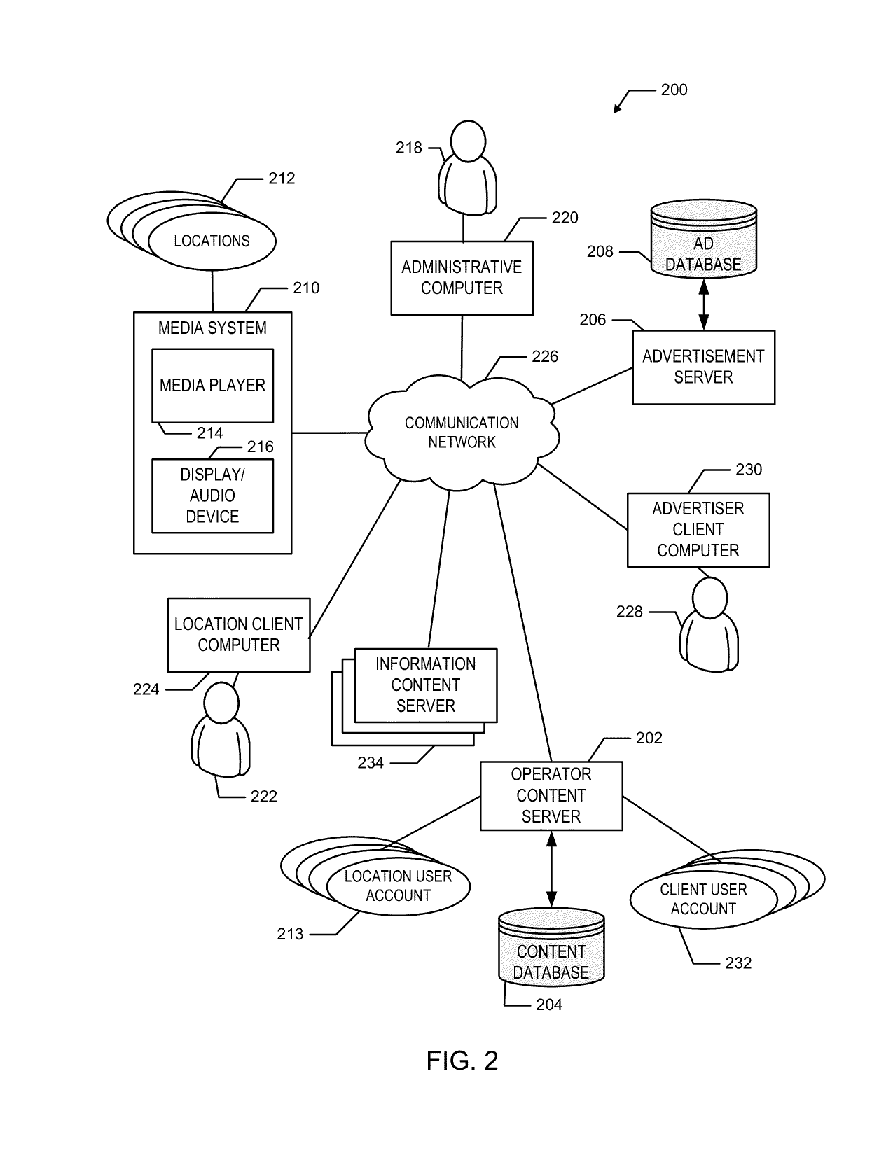

Although the AMS 100 is depicted as including a single server 102, it is contemplated, as illustrated below in FIG. 2, that the AMS 100 may include multiple servers. For example, the AMS 100 may include multiple computer systems in a cloud computing configuration.

The communication network 112 can be the Internet, an intranet, or another wired or wireless communication network. For example, communication network 112 may include a Mobile Communications (GSM) network, a code division multiple access (CDMA) network, 3rd Generation Partnership Project (3GPP), an Internet Protocol (IP) network, a Wireless Application Protocol (WAP) network, a WiFi network, or an IEEE 802.11 standards network, as well as various combinations thereof. Other conventional and/or later developed wired and wireless networks may also be used.

FIG. 1B depicts an exemplary embodiment of the client 108 according to one aspect of the AMS 100. The client 108 is a computing or processing device that includes one or more processors and memory and is configured to receive data and/or communications from, and/or transmit data and/or communications to the server 102 via the communication network 112. For example, the client 108 can be a laptop computer, a personal digital assistant, a tablet computer, standard personal computer, or another processing device. The client 108 includes a display 120, such as a computer monitor, for displaying data and/or graphical user interfaces. The client 108 may also include an input device 122, such as a keyboard or a pointing device (e.g., a mouse, trackball, pen, or touch screen) to enter data into or interact with graphical user interfaces.

Each client 108 may also include a graphical user interface (or GUI) application 124, such as a browser application, to generate a graphical user interface 126 on the display 120. The graphical user interface 126 enables a user of the client 108 to interact with various data entry forms to submit advertiser data, advertisement content, advertisement detail data, and media system data to the AMS 100 for the purpose of creating an advertisement campaign for display via one or more of the media systems 110. After entering the advertiser data, advertisement content, advertisement detail data, and media system data, an advertisement campaign creation request (campaign request) is generated. The advertisement campaign request includes the entered advertiser data, advertisement content, advertisement detail data, and the media system data and is transmitted to the AMS 100.

According to another aspect, the advertiser data, advertisement detail data, and media system data may be collected via a telecommunication device (not shown). For example, the proprietor or representative of the business may provide the advertisement detail data and/or business data to an administrator or authorized user of the AMS 100 during a telephone and/or an in-person conversation. The authorized user of the AMS 100 may use another input device (not shown) associated with the AMS 100 to complete a data entry form to generate the advertisement creation and placement request.

FIG. 1C depicts an exemplary embodiment of a data source 106 according to one aspect of the AMS 100. According to one aspect, the data source 106 stores advertiser records 128, advertisement records 130, media systems records 132, advertisement campaign records 134, and price data 136. Although the AMS 100 is depicted as including a single data source 106, it is contemplated, as illustrated below in FIG. 2, that the AMS 100 may include multiple data sources.

Each advertiser record 128 includes advertiser data for advertisers associated with the AMS 100. An advertiser can be any entity or person that desires to advertise a product, good, or service. Example advertiser data may include the name of a business, name of the user or a business representative, an account number assigned by the AMS 100, an email address, a phone number, a mailing address, and other contact information for the business. If an advertiser is a registered advertiser, the advertiser data may include authentication information (e.g., user identification code and/or a password.).

Advertiser data may further include campaign information for each particular advertiser. For example, the advertiser data may include campaign name, campaign run time, and/or media systems location information for previous advertisement campaigns and/or current advertisement campaigns deployed via the AMS 100.

Each advertisement record 130 includes information regarding the products, goods, or services offered by an advertiser. According to one aspect, the advertisement record 130 includes advertisement content and advertisement detail data. The advertisement content may include text files, video files, one or more still images files, audio files, and/or other media content files that can be rendered via a media system 110. The advertisement detail data may include information about the product(s), and/or service(s) provided by the business, advertisement type, desired display real estate, a desired run time or timeline, and other advertisement detail data.

Each media system record 132 includes information about a particular media system 110 in the AMS 100 at which advertisement campaigns can be deployed or placed. For example, a media system record 132 may include location type data, geographic data, demographic data, and available display real estate data. Each media system record 132 can also include network location data that specifies a location (e.g., URL) of a corresponding media system 110 on the communication network 112.

The location type data indicates a type of an establishment that has a media system 110 to display advertisement campaigns. For example, the location type may indicate that the media system 110 displaying the advertisement campaigns is a restaurant, a food store, an outdoor sign, or other business that has high traffic and is deemed a good location for the placement of a digital advertising system (e.g., media system 110). Other examples of location types exist. As explained below, each location may have one or more media systems 110 installed.

The geographic data identifies a physical location for each establishment having a media system 110 that can display advertisement campaigns. For example, geographic data may indicate an address, a neighborhood, a zip code, a city, a state, a region in which the establishment is located.

The demographic data identifies the type of consumers or customers that patron a particular establishment that has a media system 110. For example, the demographic data may identify a typical age, a gender, household income, and/or ethnicity of the customers that patron the particular establishment. According to one aspect, the data is obtained from, for example, survey information supplied by the particular establishment.

The available display real estate data indicates the display size or area of display space available at each media system for an advertisement campaign. For example, the display real estate data indicates the dimensions of display region available on a display device. The display real estate data may also indicate the type of advertisements that are supported by the media systems. For example, display real estate data indicates whether a particular media system 110 supports the display of banner advertisements or premium advertisements (e.g., video.)

As explained in more detail below, the advertisement campaign record 134 includes advertiser data, advertisement content, advertisement detail data, and media system data included in the advertisement campaign creation request. A particular advertiser may be associated with multiple advertisement campaign records 134.

The price data 136 includes cost information for determining a total cost of deploying an advertisement campaign and may correspond to a price schedule. The price schedule is, for example, a table that list prices for advertisement campaign options. For example, the price schedule may list prices for advertisement type (e.g., banner, premium), display real estate (e.g., size or amount of display space), content type (text, video, photo, audio) per media system location. According to one aspect, prices may vary for advertisement campaign options based on the location of the media system 100. According to other aspects, prices are uniform for advertisement campaign options across all venues. The price data can be periodically updated by administrator or authorized user of the AMS 100.

FIG. 1D depicts an exemplary embodiment of a local media system (media system) 110. Each media system 110 includes one or more processors and memory and is configured to receive data and/or communications from the server 102 via the communication network for display. The media system 110 comprises a media playing device (media player) 138, such as a smart television, a liquid crystal display (LCD), light emitting diode (LED) panel projector a digital display board, video screens, or other digital advertising medium.

The media system 110 is located at a business or merchant location that displays advertising and media content based upon a campaign definition. According to one aspect, a network operator installs the components of the media system 110 (e.g., digital screens and media players) at the particular business location. The network operator is, for example, a company that owns and/or operates the AMS 100. According to other aspects, a business entity or representative that is independent from the AMS 100 installs or has previously installed the components of the media system 110 at the particular business location.

Each media player 138 of a media system 110 may be configured to run custom application software or an Internet browser and may connect directly to an advertising screen, a LED display, a projector, or other graphic/audio device. Each media system 110 may include a local database 140 that stores advertisement data and media system data that corresponds to that particular media system. For example, the local database 140 for a particular media system may include advertisement data for advertisement campaigns deployed or previously deployed at that particular media system 110. The local database 140 may also include display real estate data to indicate the size and/or type of advertisements available for deployment at that particular media system 110. The local database may also contain log files that state the number of times or frequency the advertisement was played, media player status, files loaded, player operating time or on-time, etc.

The media player 138 of the particular media system 110 executes a local application or program (not shown) that communicates with the AMS 100 and the local database 140 to control the display time and sequence of advertising images and messages. Each media system 110 can also receive advertisement resources from the server 102, local files, or other designated sources. As used herein, advertisement resources include graphic information such as individual components, shapes, or objects included in advertisement. According to another aspect, each media system 110 may be configured to load advertisement resource information, receive news Really Simple Syndication (RSS) feed information and allow a variety of control methods for both the media unit and ad campaigns from the AMS 100, a local device, or another remote device.

FIG. 2 depicts an exemplary AMS 200 implemented with multiple servers in accordance with other aspects of the invention. The AMS 200 includes an operator content server 202 that is linked to a content database 204 and an advertisement server (ad server) 206 that is linked to advertisement database 208. The AMS 200 is also linked to multiple media systems 210 that are located at multiple locations 212. Each media system 210 includes a media player 214 and a display and/or audio device 216. According to some aspect, the media player 214 includes a local database and/or memory.

The operator content server 202 includes one or more processors and memory and executes instructions or modules that enable the creation and management of graphic content and advertising campaigns. The operator content server 202 also executes instructions or modules that enable a user to search for locations 212 of media systems 210 that match search criteria of interest to the user and to submit payment for advertisement campaigns. According to one aspect, the operator content server 202 may be accessed by location managers, advertising clients, or network operator administrators/personnel

Location managers are, for example, authorized users associated with a business or merchant location that has at least one media system 210 installed for displaying advertising campaigns. After a media system 210 is installed at a particular one of the locations 212, a location user account 213 is setup for a location manager or authorized user at that particular location 212 to access to the operator content server 202. According to one aspect, a network operator 218 uses an administrative computer 220, such as a laptop computer, a personal digital assistant, a tablet computer, standard personal computer, or another processing device to access the operator content server 202 to set up a location user account for each merchant location.

Thereafter, the location manager or other authorized user 222 may use a location client computer 224, such as a laptop computer, a personal digital assistant, a tablet computer, standard personal computer, or another processing device at the particular location to access the operator content server 202 via a communication network 226 (e.g., Internet) and web browser or via custom internet application. Such access enables a location manager to place advertising for management specials or other notices particular to the location. According to other aspects, the location manager or other authorized user 222 may use a location client computer 224, to load advertising for management specials or other notices directly onto the media player 214 located at that particular location.

An advertising user 228 is, for example, advertisers or other user that uses an advertiser client computer 230 such as a laptop computer, a personal digital assistant, a tablet computer, standard personal computer, or another processing device to access the operator content server 202 to search for and/or view availability of media system 210 where advertisement campaigns can be deployed. For example, as explained in more detail below, an advertiser may use the advertiser client computer 230 to access operator content server 202 via the communication network 226 to enter search criteria and/or view availability of media system locations that match the entered search criteria. Search criteria may include; geographic location, demographic info, type of location etc.

Although a single advertising user 228 is depicted in FIG. 2, it is contemplated that multiple advertiser can interact with one or more advertiser client computers 230 to access the operator content server 202 to set up multiple client user accounts, as indicated by reference character 232. Each client user account corresponds to or is associated with a different advertiser on the AMS 200. Alternatively, each client user account may correspond to or may be associated with a different group of advertisers on the AMS 200.

According to one aspect, the operator content server 202 stores client user account information (e.g., advertiser data) and advertisement campaign information (e.g., advertisement campaign records) in the database 204 for multiple advertisers. The database 204 may also store advertisement tools such as templates for backgrounds, adjustable font types, font sizes, images, font colors, or other advertising resources for advertisement campaigns.

According to another aspect, the operator content server 202 also executes instructions or modules that enable the advertiser to use the advertiser client computer 230 to create an advertisement campaign or upload graphics that are associated with their client user account and that can be deployed to selected locations. For example, the advertiser may use the advertiser client computer 230 to access operator content server 202 via the communication network 226 to access advertisement tools, such as templates, to create advertisement campaigns.

The ad server 206 includes one or more processors and memory and executes instructions or modules for managing the deployment of advertisement campaigns to media systems 210 at selected locations 212. According to one aspect, the ad server 206 stores advertisement data, advertisement resources, and media system data that correspond to each particular media system 210 in the advertisement database 208. For example, the ad server 206 stores advertisement campaign records that identify advertisement campaigns and corresponding timeline definition for each media player 214 linked to the AMS 200. As used herein, the timeline corresponds to start time, duration, and/or end time for displaying an advertisement campaign at a particular media system 210.

According to another aspect, the ad server 206 deploys advertisement campaigns and timelines to each media player 214 identified by a particular advertisement campaign record. Once deployed, the media player displays a particular advertisement campaign according to the timeline and other advertisement detail data included in the particular advertisement campaign.

According to another aspect, the ad server 206 is configured to monitor the status of media player at location. For example, the ad server 206 can detect which, if any, advertisement campaigns are currently deployed at a particular media system location 212 and/or are currently being displayed. As another example, the ad server 206 can determine an amount of time until a particular advertisement campaigns begins and/or ends.

According to another aspect, the ad server 206 is configured to remotely control the operation of media players 214. For example, the network operator 218 uses the administrative computer 220 to access the ad server 206 to terminate an advertisement campaign being displayed at a particular media player 214. As another example, the network operator 218 uses the administrative computer 220 to access the ad server 206 to extend the timeline associated with a particular an advertisement campaign deployed at a particular media player 214.

According to another aspect, the ad server 206 is configured to receive a disapproval notification from the media system 210 for a particular campaign deployed to that media system 210. For example, the location manager or other authorized user 222 may use the location client computer 224 to generate and send the disapproval notification to the ad server 206 when the particular campaign is not in compliance with the advertisement campaign standards for that particular location or otherwise not desired for display at that particular location. The ad server 206 updates a corresponding campaign record in the ad database 208 to identify the advertisement campaign as disapproved for display at that particular location. According to another aspect, the ad server 206 then sends a campaign disapproval notification to the advertiser client computer 230.

According to another aspect, the ad server 206 includes an interface program or application that when executed enables the network operator 218 to create and develop ad campaigns, managing graphic resources, managing & configuring location media players.

In other aspect, the AMS 200 is optionally configured to receive information from one or more information content servers 234 via the communication network 226. The information content server is, for example, an alternate or open access website/server that has information that can be accessed and/or displayed by the media systems 210. The information that can be accessed and/or displayed includes, for example, Weather, RSS news feeds, and sports scores.

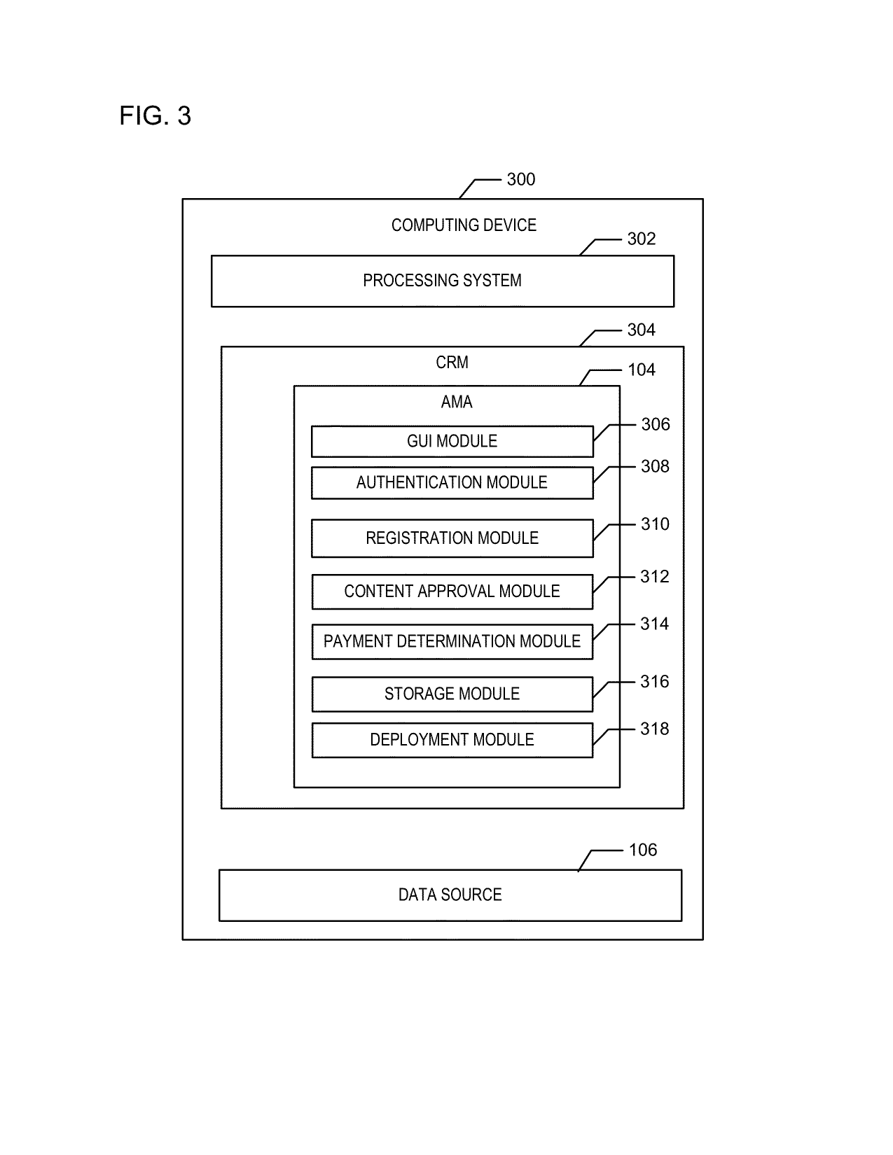

FIG. 3 is a block diagram depicting an exemplary AMA 104 executing on a computing device 300 (e.g., server 102). According to one aspect, the computing device 300 includes a processing system 302 that includes one or more processors or other processing devices. The processing system 302 executes the AMA 104 to process advertiser data, advertisement data, and/or media system data received from a remote computing device (e.g., client 108) to create an advertisement campaign for selective deployment at one or more media systems (e.g., media system 110).

According to one aspect, the computing device 300 includes a computer readable medium (“CRM”) 304 configured with the AMA 104. The AMA 104 includes instructions or modules that are executable by the processing system 302 to manage the creation and deployment of advertisement campaign. For purposes of illustration, the AMA 104 is depicted as being executed by a single computing device. However, as explained above, it is contemplated that two or more computing devices (e.g., an operator content server 202 and ad server 206) may be used in other embodiments to execute the instructions or modules described hereafter.

The CRM 304 may include volatile media, nonvolatile media, removable media, non-removable media, and/or another available medium that can be accessed by the computing device 300. By way of example and not limitation, the CRM 304 comprises computer storage media and communication media. Computer storage media includes nontransient memory, volatile media, nonvolatile media, removable media, and/or non-removable media implemented in a method or technology for storage of information, such as computer readable instructions, data structures, program modules, or other data. Communication media may embody computer readable instructions, data structures, program modules, or other data and include an information delivery media or system.

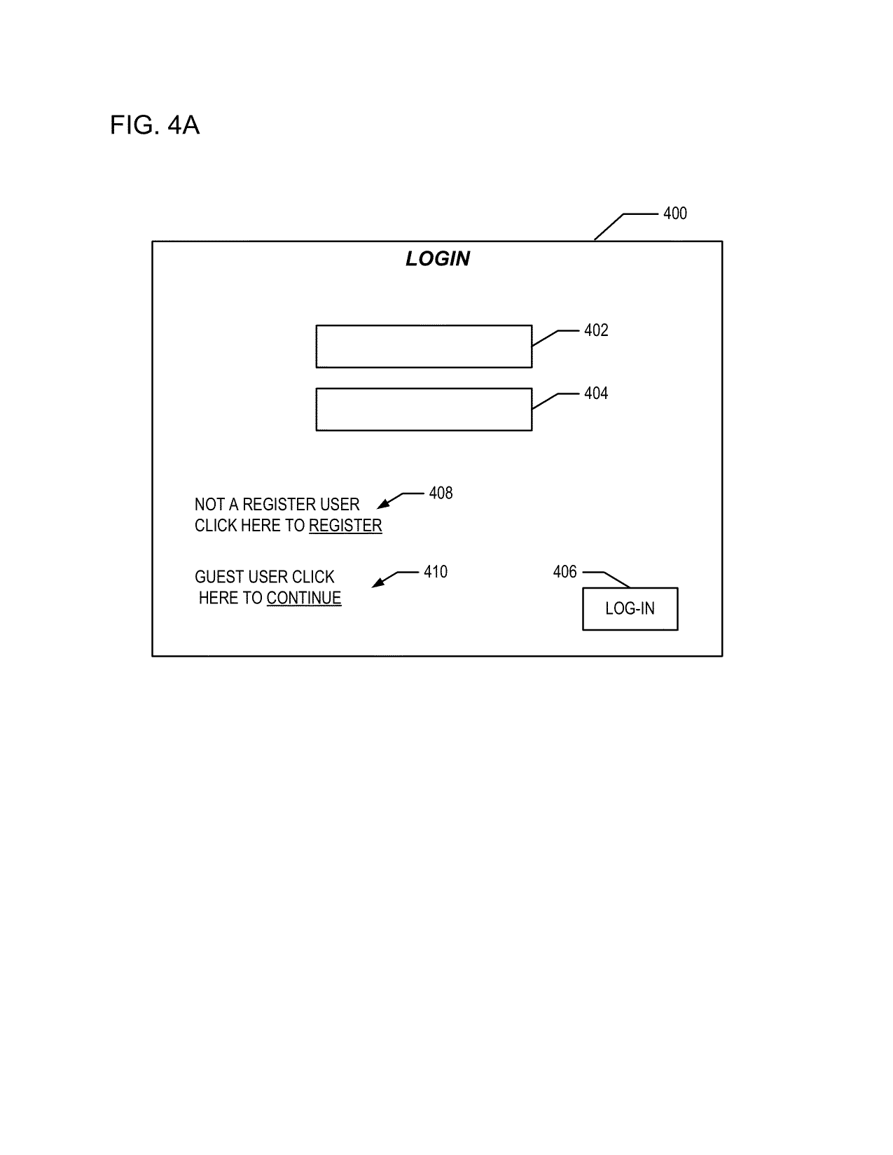

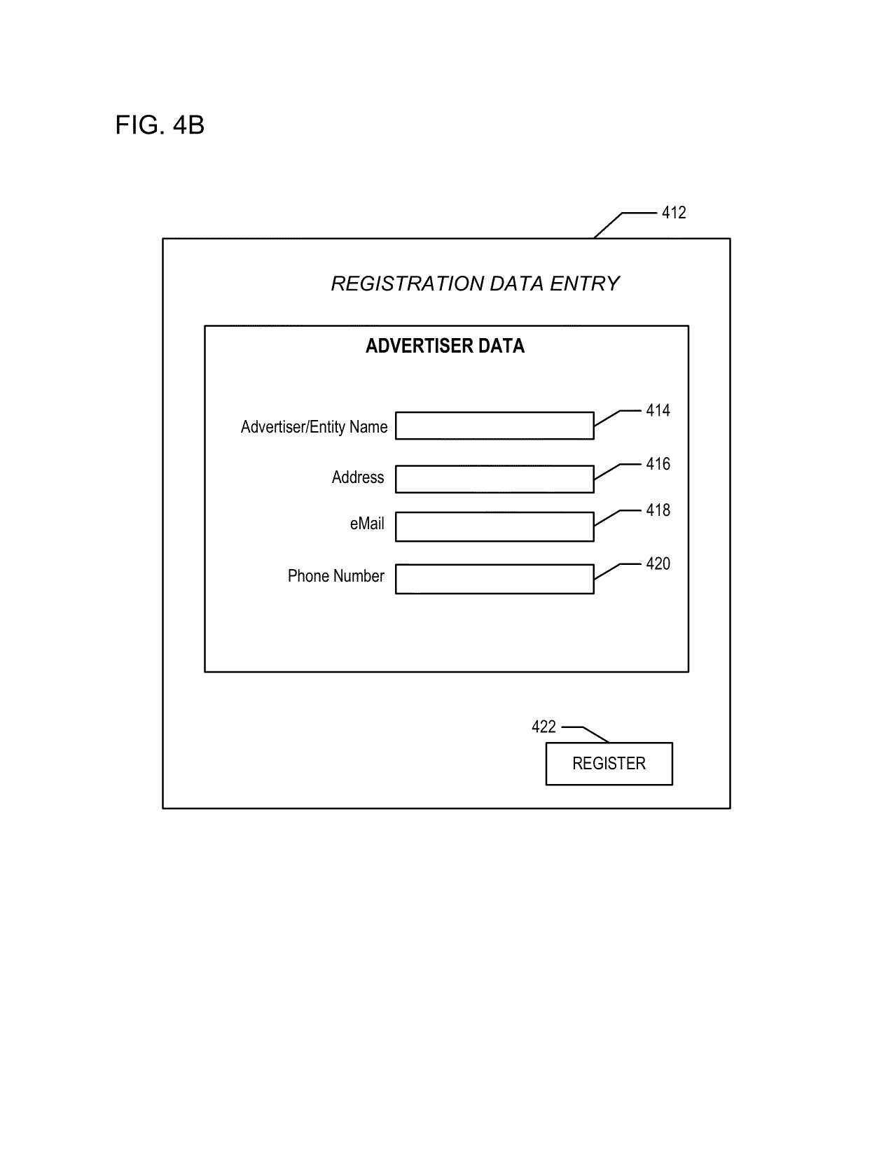

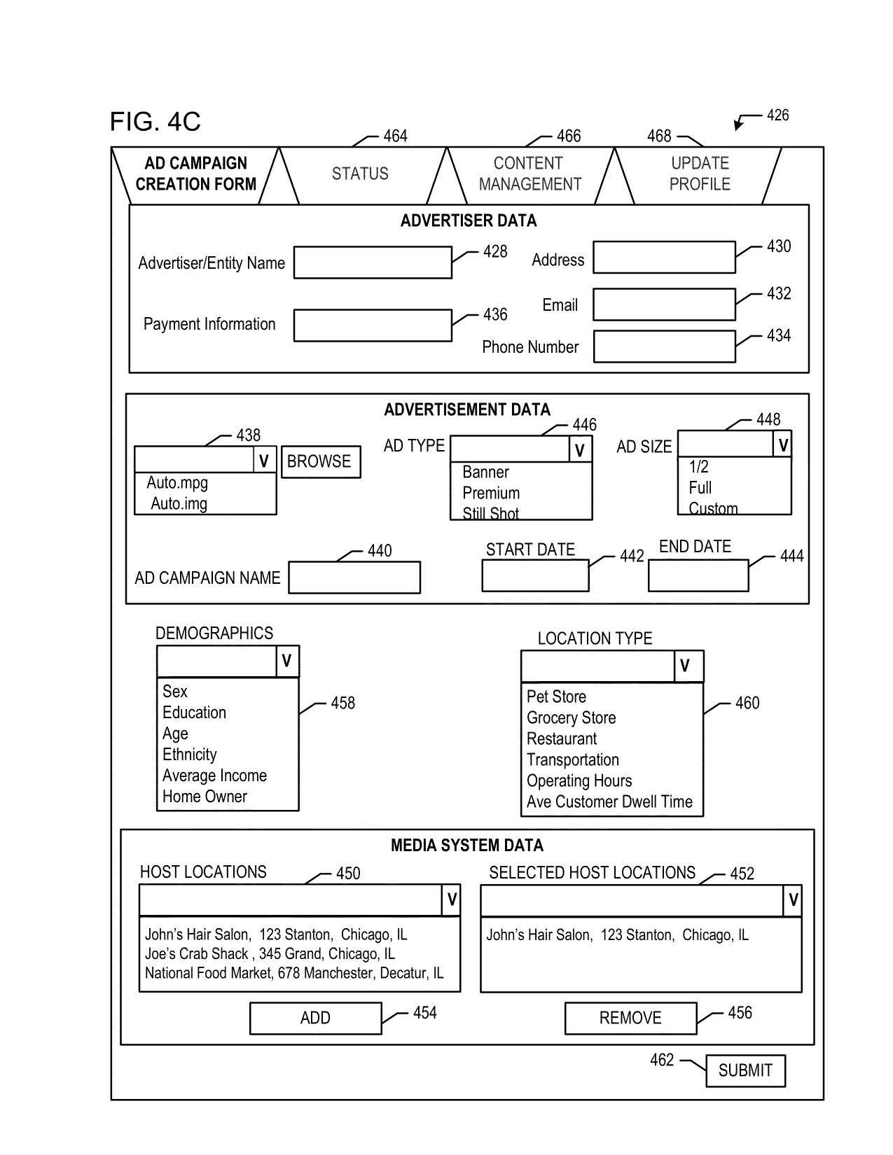

A GUI module 306 transmits a login form to a particular remote device 108 after the AMA 104 receives the access request from that remote device 108. The user of the remote device 108 can interact with the login form to view a registration form and/or an advertisement campaign management form. FIGS. 4A, 4B, and 4C depict exemplary screen shots of a log-in form, a registration form, and the advertisement campaign management form, respectfully, transferred to the remote device 108 by the GUI module 306.

FIG. 4A depicts an exemplary login form 400 according to one aspect of the AMS 100. The login forms 400 is, for example an HTML document, such as a web page that includes an user identification (user id) input field 402 for entering a user id and a password input field 404 for entering a password that corresponds to a selected text object or a selected image object. After the user enters the user id and password and selects a log-in control 406, an authentication request is generated that includes the user id and password and is sent to the AMS 100.

The login form 400 may include an option control that allows users to bypass the login form and go directly to the advertisement campaign management form. For example, if the user has not previously elected to register with the AMS 100, the user can register with the AMS 100 by selecting a register option 408 and by supplying biographical information (e.g., name, address, e-mail, etc.) and user authentication data (e.g., user id and password). Alternatively, the user can use the AMS 100 as a guest user by selecting a guest option 410 displayed on the form. After the user selects the guest option, a guest registration request is transmitted to the AMS 100. Thus, although the guest user is not logged-in, the guest user has access to the AMS 100. Stated differently, membership is not required to access the AMS 100 to create an advertisement campaign for selective deployment at one or more media systems (e.g., media system 110).

If the user is registered with the AMS 100 and enters valid authentication data (user id and a password input), the advertisement creation form is transmitted to the client 108 for display. The login form 400 depicted in FIG. 4A is meant to be non-limiting. Other examples of login forms exist.

FIG. 4B depicts an exemplary registration form 412 that enables the user to enter advertiser registration data to register with the AMS 100. The registration forms 412 is, for example, an HTML document, such as a web page that includes an advertiser/entity name field 414, advertiser address field 416, e-mail field 418, and phone number field 420. The advertiser/entity name field 414 enables the user to enter the name of the business/advertiser requesting advertisement for products, goods, or services. The advertiser address field 416 enables the user to enter a mailing and/or billing address associated with the business/advertiser. The e-mail address field 418 enables the user to enter an e-mail address associated with the business/advertiser. The phone number field 420 enables the user to enter a telephone number associated with the business/advertiser. After the user enters advertiser data and selects registration control 422, a registration request is generated that includes, for example, advertiser/entity name, advertiser address, e-mail, phone number, payment information and is sent to the AMS 100. The registration form 412 depicted in FIG. 4B is meant to be non-limiting. Other examples of registration forms exist.

FIG. 4C depicts an exemplary advertisement campaign management form 426 that enables the user to enter advertiser data and, advertisement data and to select media system data for the placement of an advertisement. In this example, the advertisement campaign management form 426 includes advertiser entry data fields, advertisement data entry fields, and media system data selection fields. The advertiser data entry fields include, for example, an advertiser/entity name field 428, advertiser address field 430, e-mail field 432, phone number field 434, and a payment information filed 436. The advertiser data entered in these fields may be substantially the same type of data entered in the corresponding fields described above in connection with FIG. 4B.

According to one aspect, if the user is a guest user, the user interacts with the advertiser data entry fields to enter the advertiser data. If the user is an authorized user, advertiser data entry fields may be automatically populated based on stored registration data.

The advertisement entry data fields enable a user to enter advertisement content and advertisement detail data. For example, advertisement entry data fields include an advertisement content field 438, advertisement campaign name field 440, and start date and end date fields 442, 444, advertisement type field 446, and advertisement size field 448. The advertisement content field 414 enables the user to browse content files on the client 108 and to select content data, such as image or video files to upload to the AMS 100. The advertisement campaign name field 440 enables the user enter a name for the advertisement. The start date and end date fields 442, 444 enable a user to define a timeline (e.g., run time) for the advertisement campaign by entering a start date and end date, respectively. The advertisement type field 446 enables a user to specify and advertisement type, such as banner, premium, full screen, any zones defined on media player, and sponsorships. Other examples of advertisement types exist. The advertisement size field 424 enables a user to select an advertisement size from a list of predefined dimensions or add sizes. Advertisement sizes may be full screen, sponsorship bug, banner, or other zones available on the media player. Other examples of advertisement sizes exist.

The media system data selection fields include a selection list box 450 and a selected list box 452. The selection list box 450 includes a list of media system locations available to display advertisements. The selected list box 452 includes a list of media system locations selected to display a particular advertisement.

According to one aspect, the user selectively adds media system locations to the selected list box 452 by selecting (e.g., mouse click) one or more media system locations in the selection list box 450 and then selecting an add control 454 displayed on the advertisement campaign management form 426. In addition, the user can selectively remove media system locations from the selected list box 452 by selecting (e.g., mouse click) one or more names in the selected list box 452 and then selecting a remove control 456 displayed on the advertisement campaign management form 426.

According to another aspect, the advertisement campaign management form 426 includes filtering controls that enable the user to filter the number media system locations displayed in, for example, the selection list box 450. For example, a demographics filter control 458 enables a user to select demographic criteria to search the media system records 132 in the data source 106 to identify media systems 110 that match the demographic criteria. Thereafter, the corresponding media system locations are displayed in the selection list box 450. Examples of filtering or sorting demographic criteria that may be selected via the demographics filter control 458 include a typical age, a gender, household income, and/or ethnicity of the customers that patron the particular establishment.

As another example, a location filter control 460 also enables the user to select location criteria to select location criteria to search the media system records 132 in the data source 106 to identify media systems 110 that match the demographic criteria. Thereafter, the corresponding media system locations are displayed in the selection list box 450. Examples of filtering or sorting location criteria that may be selected via the location filter control 460 include type of venue, geographic location, hours of operation, number of display screens in the location, weekly transactions, traffic volume, location visibility, available advertisement positions on display screen, and dates available.

According to one aspect, the demographics filter control 458 and the location filter control 460 can be used in conjunction to filter the number media system locations displayed in, for example, the selection list box 450. After the user enters data into the advertiser entry data fields, advertisement data entry fields, and media system data selection fields, the user selects for example, a “submit” control 462, to generate an advertisement campaign creation request that includes the advertiser data, advertisement content, advertisement detail data, and media system data that is sent to the AMS 100.

According to another aspect, the advertisement campaign management form 426 includes terms of service option control (not shown) must be acknowledged or selected before an advertisement campaign request can be generated. For example, the terms of service option control may be positioned adjacent to a scrollable list box that includes the terms and condition that users agree to accept by selecting the option control.

The advertisement campaign management form 426 depicted in FIG. 4C is meant to be non-limiting. Other examples of advertisement campaign management forms exist. For example, the advertisement campaign management form 426 may be split into multiple forms. A first advertisement campaign management form may include the fields for entering advertiser data, such as advertiser name, campaign dates, email, address, etc. A second advertisement campaign management form may include the filtering controls for filter the number media system locations displayed based on selecting of the location features/demographics. A third advertisement campaign management form may include fields for displaying the results of the search, selection of a location, displaying specific information of the location, ad spot pricing & modifying the search criteria.

Referring back to FIG. 3, an authentication module 308 determines if a user has provided valid authentication data, such as a correct user id and/or password via an authentication request received from the client 108. If the authentication request includes valid authentication data, the authentication module 308 designates the user as being an authorized user and is logged-into the AMS 100 and the GUI module 306 displays the advertisement campaign management form. If the authentication request does not include valid authentication data, the authentication module 308 sends a notification to the client 108 that authentication data is invalid and the user is not logged-in to the AMS 100. According to one aspect, authentication module 308 may designate the user as being a guest user. Although the guest user is not logged-in, the guest user has access to the AMS 100.

A registration module 310 assigns an account number to an advertiser in response to a registration request received from the client 108 and the GUI module 306 displays the advertisement campaign management form. The registration module 310 also generates an advertiser record (e.g., advertiser record 128) for storage in the data source 106. The advertiser record may include authentication data, such as username and password, the assigned account number, and other advertiser data. The other advertiser data in the advertiser record includes, for example, the advertiser/entity name, the advertiser address, the advertiser e-mail address, the advertiser phone number, and the advertiser payment information (e.g., payment method and card/bank account number)

According to another aspect, the registration module 310 assigns an account number to a guest advertiser in response to a guest registration request received from the client 108 and the GUI module 306 displays the advertisement campaign management form. In this case, the advertiser record (e.g., advertiser record 128) generated by the registration module includes a guest flag that indicates that the advertiser is a guest user, the assigned account number, and other advertiser data. The guest flag attribute can be a code, symbol, or other indicator.

A content approval module 312 processes the advertisement content included in a received advertisement campaign creation request for errors and/or appropriateness. For example, the content approval module 312 initiates a spell checking process to detect spelling errors in textual content included in the advertisement content data. The spell checking process may also include comparing word included in the advertisement content to a list or words that are considered offensive. The content approval module 312 is configured to send an error notification to the client 108 when a spelling error is detected and to send an inappropriate content notification when offensive textual content (e.g., word) is detected.

According to another aspect, the content approval module 312 initiates an image review process to detect offensive images in video and/or image content. The image review process may involve sending textual content, video content and/or image content to an administrative computer (not shown) for visual examination by an administrator for approval. Alternatively, the image review process may involve using a pattern recognition algorithm to detect potentially offensive image content. The content approval module 312 sends an inappropriate content notification to the client 108 when offensive image content (e.g., photo or video) is detected. The content approval module 312 designates the advertisement content approved if no offensive textual or image content is detected.

According to another aspect, the content approval module 312 is responsive to a disapproval notification from a particular media system 110 to generate a campaign disapproval notification for a particular campaign deployed to that particular media system 110. For example, as described above, the location manager or other authorized user may use a location client computer to send a disapproval notification to the computing device 300 when the particular campaign is not in compliance with the advertisement campaign standards for that particular location or other wise not desired for display at that particular location. The content approval module 312 may also send the campaign disapproval notification to the client computer 108 for display.

A payment determination module 314 determines a payment amount for an advertisement campaign based on the advertisement content and advertisement detail data included in a corresponding advertisement campaign creation request. According to one aspect, the payment determination module 314 determines a price for a particular advertisement based on pricing data included in a retrieved price schedule and the advertisement content, advertisement detail data, and media system data included in the advertisement campaign creation request. The price schedule is, for example, a table that list prices for advertisement detail options per media system 100 location. For example, the price schedule may list prices for advertisement type (e.g., banner, premium), display real estate (e.g., size or amount of display space), content type (text, video, photo, audio) per media system location. According to one aspect, prices may vary for advertisement detail options per venue. According to other aspects, prices are uniform advertisement detail options across all venues.

By comparing the advertisement data and location data to the pricing schedule, the payment determination module 314 determines the price for a particular advertisement by summing the cost for each advertisement detail options. This process for determining the price exemplary and is not meant to be limiting as it is contemplated that other methods could be used to determine the price of an advertisement in accordance with aspects of the invention.

According to one aspect, the GUI module 304 generates a summary form (not shown) that includes an advertisement summary after the price is determined. The summary may identify the name of the advertisement campaign, the media system location, total run time, and payment amount.

According to another aspect, the payment determination module 314 determines a payment method based on whether the user is a non-logged-in user (e.g., a guest user) or a logged-in user (e.g., authenticated user). For non-registered user and/or guest users, an electronic payment form (not shown) is immediately generated and transmitted to the client. The electronic payment form includes a payment information field that enables the user to enter a payment method for the business/advertiser, such as a credit card, a bank Automated Clearing House (ACH) transfer, and/or PayPal, etc. After the guest user submits payment information and payment confirmation has been received from the financial institution, the payment determination module 314 generates a payment confirmation notification and assigns an account number to the guest user.

For a registered user and/or authenticated user, the payment determination module 314 transmits the electronic payment form (not shown) to the client so the registered user can immediately submit payment information. Alternatively, rather than requiring immediate payment, the payment determination module 314 generates a payment confirmation notification immediately upon the content approval module 312 designating the advertisement content approved and the registered user may optionally be billed at the end of a billing cycle.

A storage module 316 stores an advertisement campaign record for each approved advertisement campaign creation request. The advertisement campaign record includes advertiser data, advertisement content, advertisement detail data, and media system data included in the advertisement campaign creation request. For example, for registered advertisers, the advertisement record may include the advertiser's assigned account number, the advertiser's name, the advertisement campaign name, advertisement content, advertisement detail data, and selected media system data.

A deployment module 318 then transmits an advertisement campaign to the one or media systems 110 designated by the media system data included in the advertisement campaign record. The advertisement campaign includes the advertisement content configured according to the advertisement detail data. Thereafter, each designated media system 110 displays an advertisement campaign according to the advertisement data. For example, the media system 110 displays an advertisement campaign that includes the advertisement content in the advertisement type and advertisement size from the start date to the end date in the advertisement campaign record.

Referring back to FIG. 4C, according to another aspect, the advertisement campaign management form 426 includes a status tab 464 that enables a user to view a status form (not shown). A user can interact with the status form to enter, for example, a particular advertisement campaign name and/or a particular account number assigned to an advertiser (e.g., registered or guest) to view status information for one or more previously created advertisement campaigns. For example, by entering the advertisement name in the status form, the user can view status information for a particular campaign, such as whether it is currently running, pending, expired, or not approved. As another example, by entering the account number in the status form, the user can view status information of all campaigns associated with that account number. The status form may also display advertisement data and/or the one or more media systems designated for displaying the particular advertisement campaign.

According to another aspect, the advertisement campaign management form 426 includes a content management tab 466 that enables a user to view a content management form (not shown). A user can interact with the content management form to enter, for example, a particular advertisement campaign name and/or a particular account number assigned to an advertiser (e.g., registered or guest) to view advertisement content included in a particular advertisement campaign record. The user can interact with the content management form to view, edit or delete advertisement content included the particular advertisement campaign record. For example, the content management form includes advertisement design tools that enable the user create, edit, or delete an advertisement layout for the particular campaign. The advertisement design tools enable the user to create multiple sized screen areas using base templates for backgrounds, adjustable font types, font sizes, and font colors for the particular campaign.

According to another aspect, the advertisement campaign management form 426 includes an update profile tab 468 that enables a user to view a profile management form (not shown). A user can interact with the profile management form to enter, for example, a particular advertisement campaign name and/or a particular account number assigned to an advertiser (e.g., registered or guest) to view advertiser data included in a particular advertiser record. The user can interact with the profile management form to view, edit or delete advertiser data included the particular advertiser record.

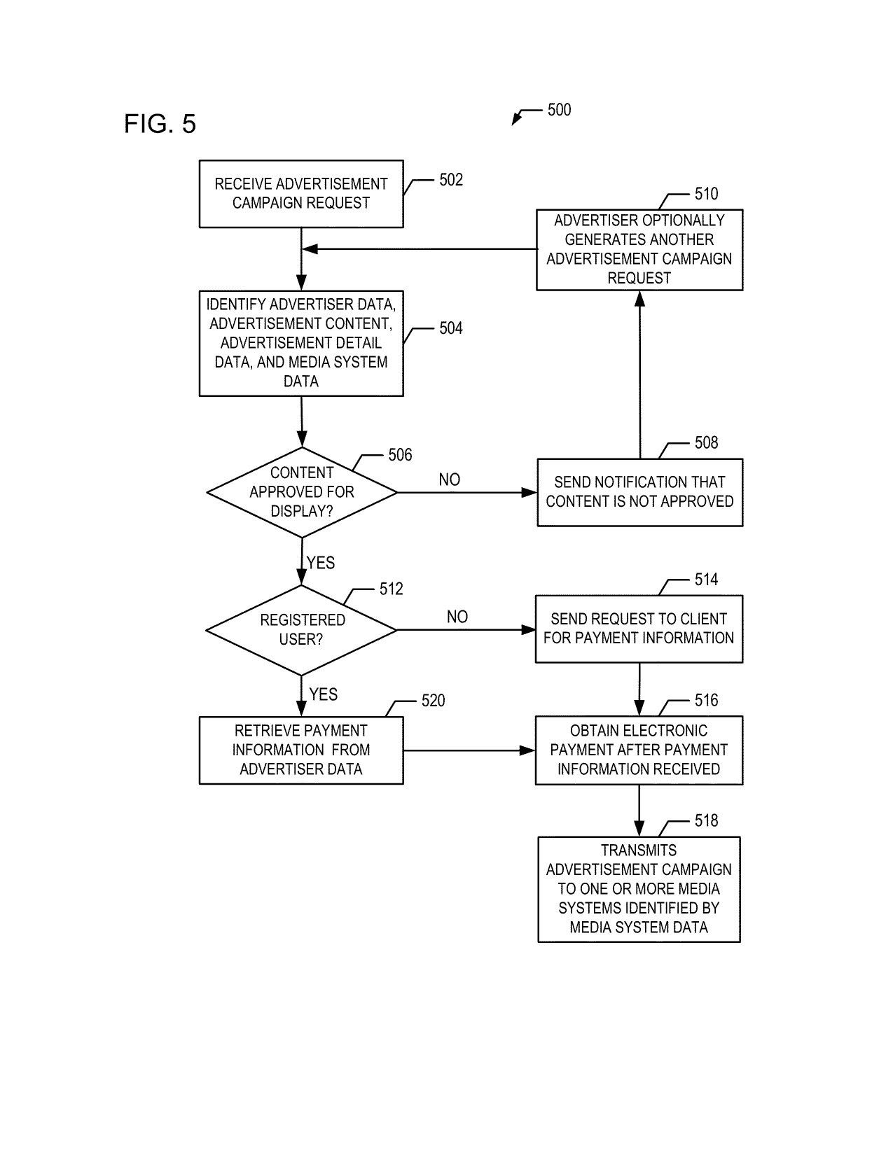

FIG. 5 depicts an exemplary embodiment of an advertisement deployment process 500 executed by at least one processor encoded with, or executing instructions of, an AMA 104. At 502, the AMA receives an advertisement campaign creation request from a remote client computing device (e.g., client 108) associated with a particular advertiser. The AMA 104 processes the advertisement campaign creation request to identify advertiser data, advertisement content, advertisement detail data, and media system data at 504. At 506, the AMA 104 automatically processes the advertisement content and/or sends to an administrative user to processes the advertisement content to determine if the advertisement content is approved for display.

If the advertisement content is determined to be non-approved content at 506, a notification is transmitted to the client that the supplied advertisement content is not approved at 508 and the user has the option to submit an another advertisement campaign creation request at 510. The AMA determines if the advertisement campaign creation request is from a registered user or a guest user at 512. According to an alternative aspect, if the advertisement content is determined to be approved content at 506, the AMA determines a price for generating an advertisement campaign based on the advertisement content and advertisement detail data included in the advertisement campaign creation request.

If the advertisement campaign creation request is determined to be from a guest or non-registered at 512, the AMA 104 sends a request for payment information to the client at 514. The AMA 104 obtains payment electronically after receiving payment information from the client at 516. The AMA 104 transmits the advertisement campaign to one or more media systems 110 identified by the media system data included in the advertisement campaign creation request at 518. As described above, the media system will display the advertisement content according to the corresponding detail data.

If the advertisement campaign creation request is determined to be from an authorized or registered at 512, the AMA 104 retrieves payment information from the advertiser data included advertisement campaign creation request at 520 and obtains payment electronically at 516. At 104 transmits the advertisement campaign to one or more media systems 110 identified by the media system data included in the advertisement campaign creation request at 520.

Combinations and/or sub-combinations of the above and systems, modules, components, and methods described herein may be made.

Those skilled in the art will appreciate that variations from the specific embodiments disclosed above are contemplated by the invention. The invention should not be restricted to the above embodiments, but should be measured by the following claims.

What is claimed is:

1. A system for deploying an advertisement campaign comprising:
at least one data source comprising media system data, the media system data comprising:
a list of a plurality of media systems; and
a network location for each of the plurality of media systems; and
at least one processor encoded with a plurality of instructions, the at least one processor executing the plurality of instructions to:
process advertisement content included in a received advertisement campaign creation request to determine if the advertisement content comprises approved advertisement content, the received advertisement campaign creation request further comprising advertisement detail data and a selection of at least one of the plurality of media systems, wherein the advertisement detail data comprises an advertisement type, an advertisement size, a start date, and an end date;
generate an advertisement campaign when the advertisement content is approved advertisement content, the advertising campaign comprising the approved advertisement content and the advertisement detail data; and
transmit the advertisement campaign to the selection of the at least one plurality of media systems at a corresponding network location to display the approved advertisement content.

2. The system of claim 1 wherein the plurality of instructions executed by the at least one processor comprises a pattern recognition algorithm to process the advertisement content to determine if the advertisement content comprises approved advertisement content.

3. The system of claim 1 wherein the plurality of instructions executed by the at least one processor displays the advertisement content to enable a visual examination by an administrative user to determine whether the advertisement content comprises approved advertisement content.

4. The system of claim 1 wherein the plurality of instructions executed by the at least one processor are further configured to:
determine a price for advertisement campaign based on the advertisement detail data and the selection of at least one of the plurality of media systems;
receive a payment request comprising an electronic payment for the price; and
wherein the advertisement campaign is transmitted to the selection of the at least one plurality of media systems after receiving the payment request.

5. The system of claim 1 wherein the plurality of instructions executed by the at least one processor are further configured to transmit at least one data entry form to a client computing device, wherein the at least one data entry form enables a user of the client computing device to enter the advertisement content and the selection of the at least one plurality of media systems to generate the advertisement campaign creation request.

6. The system of claim 1, wherein the advertisement content comprises at least one of media content, textual content, and audio content.

7. The system of claim 1 wherein the advertisement campaign is transmitted to the at least one plurality of media systems to display the content according to the advertisement detail data.

8. The system of claim 1 wherein the advertisement campaign is transmitted to the at least one plurality of media systems to display the content from the start date to the end date.

9. The system of claim 1 wherein:
the media system data comprises corresponding geographic data and corresponding location data for each of the plurality of media systems; and
the instructions executed by the at least one processor are further configured to
receive a query request comprising at least one of a geographic parameter and a location parameter;
generate a second list of the plurality of media system each comprising media system data that corresponds to the at least one of a geographic parameter and a location parameter; and
wherein the selection of the at least one of the plurality of media systems is from the second list.

10. The system of claim 1 wherein the at least one processor comprises:
a first processor to execute a first set of the plurality of instructions to:
process the advertisement content included in a received advertisement campaign creation request to determine if the advertisement content comprises approved advertisement content; and
generate the advertisement campaign when the advertisement content is approved advertisement content; and
a second processor to execute a second set of the plurality of instructions to transmit the advertisement campaign to the selection of the at least one plurality of media systems at a corresponding network location to display the approved advertisement content.

11. A method for deploying an advertisement campaign comprising:
retrieving media system data from a data source, the media system data comprising a network location for each of a plurality of media systems;
transmitting the network location for each of a plurality of media systems to a remote computing device for display;
receiving an advertisement campaign creation request from the remote computing device at at least one processor, the advertisement campaign creation request comprising advertisement content, advertisement detail data, and a selection of at least one of the plurality of media systems, and wherein the advertisement detail data comprises an advertisement type, an advertisement size, a start date, and an end date;
processing the advertisement content at the at least one processor to determine if the advertisement content comprises approved advertisement content for display;
generating an advertisement campaign at the at least one processor when the advertisement content comprises approved advertisement content, the advertising campaign comprising the approved advertisement content and the advertisement detail data; and
transmitting the advertisement campaign to the selection of the at least one plurality of media systems at a corresponding network location to display the approved advertisement content.

12. The method of claim 11 wherein the processing comprises executing a pattern recognition algorithm to determine if the advertisement content comprises approved advertisement content.

13. The method of claim 11 wherein the processing comprises displaying the advertisement content to enable a visual examination by an administrative user to determine whether the advertisement content comprises approved advertisement content.

14. The method of claim 11 further comprising:
determining a price for advertisement campaign based on the advertisement detail data and the selection of at least one of the plurality of media systems;
receiving a payment request comprising an electronic payment for the price; and
transmitting the advertisement campaign to the selection of the at least one plurality of media systems after receiving the payment request.

15. The method of claim 11 further comprising transmitting at least one data entry form to the remote computing device, wherein the at least one data entry form enables a user of the client computing device to enter the advertisement content and the selection of the at least one plurality of media systems to generate the advertisement campaign creation request.

16. The method of claim 11 the wherein the media system data further comprises corresponding geographic data and corresponding location data for each of the plurality of media systems, the method further comprising:
receiving a query request comprising at least one of a geographic parameter and a location parameter; and
generating a second list of the plurality of media system each comprising media system data that corresponds to the at least one of a geographic parameter and a location parameter, wherein the selection of the at least one of the plurality of media systems is from the second list.

17. A system for deploying an advertisement campaign comprising:
at least one data source comprising media system data, the media system data comprising:
a list of a plurality of media systems; and
a network location for each of the plurality of media systems; and
at least one processor encoded with a plurality of instructions, the at least one processor executing the set of instructions to:
process advertisement content included in a received advertisement campaign creation request to determine if the advertisement content comprises approved advertisement content, the received advertisement campaign creation request further comprising advertisement detail data and a selection of at least one of the plurality of media systems, wherein the advertisement detail data comprises an advertisement type, an advertisement size, a start date, and an end date;
generate an advertisement campaign when the advertisement content is approved advertisement content, the advertising campaign comprising the approved advertisement content and the advertisement detail data; and
determine a price for the advertisement campaign based on the advertisement detail data and the selection of at least one of the plurality of media systems;
receive a payment request comprising an electronic payment for the price; and
transmitting the advertisement campaign to the selection of the at least one plurality of media systems after receiving the payment request.

18. The system of claim 17 wherein:
the media system data comprises corresponding geographic data and corresponding location data for each of the plurality of media systems; and
the instructions executed by the at least one processor are further configured to
receive a query request comprising at least one of a geographic parameter and a location parameter;
generate a second list of the plurality of media system each comprising media system data that corresponds to the at least one of a geographic parameter and a location parameter; and
wherein the selection of the at least one of the plurality of media systems is from the second list.

19. The system of claim 17 wherein the plurality of instructions executed by the at least one processor are further configured to transmit at least one data entry form to a client computing device, wherein the at least one data entry form enables a user of the client computing device to enter the advertisement content and the selection of the at least one plurality of media systems to generate the advertisement campaign creation request.

20. The system of claim 17 wherein the advertisement campaign is transmitted to the at least one plurality of media systems to display the content:
according to the advertisement detail data; and
from the start date to the end date.

21. A system for deploying an advertisement campaign comprising:
at least one data source comprising media system data, the media system data comprising:
a list of a plurality of media systems; and
a network location for each of the plurality of media systems; and
at least one processor encoded with a plurality of instructions, the at least one processor executing the plurality of instructions to:
receive an advertisement campaign creation request, the advertisement campaign creation request comprising advertisement content, a selection of at least one of the plurality of media systems, and advertisement detail data, wherein the advertisement detail data comprises an advertisement type, an advertisement size, a start date, and an end date;
generate an advertisement campaign based on the advertisement content and the advertisement detail data included in the advertisement campaign creation request; and
transmit the advertisement campaign to the selection of the at least one plurality of media systems at a corresponding network location to display the approved advertisement content.

22. The system of claim 21 wherein the plurality of instructions executed by the at least one processor are further configured to:
process the advertisement content included in the advertisement campaign creation request to determine if the advertisement content comprises approved advertisement content; and
generate the advertisement campaign when the advertisement content is approved advertisement content, the advertising campaign comprising the approved advertisement content and the advertisement detail data.

23. The system of claim 22 wherein the plurality of instructions executed by the at least one processor comprises a pattern recognition algorithm to process the advertisement content to determine if the advertisement content comprises approved advertisement content.

24. The system of claim 22 wherein the plurality of instructions executed by the at least one processor displays the advertisement content to enable a visual examination by an administrative user to determine whether the advertisement content comprises approved advertisement content.

25. The system of claim 21 wherein the plurality of instructions executed by the at least one processor are further configured to:
receive a disapproval notification from the at least one plurality of media systems corresponding to the advertisement campaign; and
generate a campaign disapproval notification for the advertisement campaign for display.
